(19) United States
(12) Patent Application Publication
(10) Pub. No.: US 2023/0393001 A1
(43) Pub. Date: Dec. 7, 2023

(54) FLARE TESTING ARRANGEMENT

(71) Applicant: Hydro Extrusion USA, LLC, Rosemont, IL (US)

(72) Inventors: Nathan Nickolopoulos, Rosemont, IL (US); Rob Wendt, Troy, MI (US)

(21) Appl. No.: 17/831,079

(22) Filed: Jun. 2, 2022

(51) Int. Cl. G01L 5/00; G01B 21/02

(52) U.S. Cl. CPC G01L 5/0038; G01L 5/0061; G01B 21/02

(57) ABSTRACT

A flare testing arrangement for a hollow body, the hollow body having at least one hollow section extending in a longitudinal direction of the hollow body. The arrangement includes a first fixture, a second fixture, a resilient element, and an actuator configured to exert a force on the first or second fixtures. A cross-sectional area across a longitudinal direction of the first and second fixtures and the resilient element has a shape corresponding to the shape of the cross-sectional area across a longitudinal direction of a corresponding hollow section of the hollow body.

### TECHNICAL FIELD

The invention relates to a flare testing arrangement for a hollow body and a method for flare testing of a hollow body by a flare testing arrangement according to the appended claims. The invention also relates to a computer program product and a computer-readable medium according to the appended claims.

### BACKGROUND

The background description provided herein is for the purpose of generally presenting the context of the disclosure. The work of the presently named inventors, to the extent it is described in this background section, as well as aspects of the description that may not otherwise qualify as prior art at the time of filing, are neither expressly nor impliedly admitted as prior art against the present disclosure.

Hollow bodies, such as extruded or welded hollow bodies, are used as components in various applications. In some applications, the hollow bodies may have a load-bearing function and may be exposed to great stress.

In order to construct and design the hollow body to resist such stresses and prevent the hollow body, as component of a structure to fail, the hollow bodies are flare tested. Depending on the result of the flare testing, the hollow body may be designed and adapted to resist stresses and forces it is intended to be subjected to as a component of a structure.

### SUMMARY

The following presents a simplified summary of the present disclosure in order to provide a basic understanding of some aspects of the disclosure. This summary is not an extensive overview of the disclosure. It is not intended to identify key or critical elements of the disclosure or to delineate the scope of the disclosure. The following summary merely presents some concepts of the disclosure in a simplified form as a prelude to the more detailed description provided below.

In some embodiments, the disclosure describes a flare testing arrangement for a hollow body. The hollow body may have at least one hollow section extending in a longitudinal direction of the hollow body. The arrangement may include at least one first fixture, at least one second fixture, at least one resilient element, and at least one actuator. Each actuator may be configured to exert a force on at least one of the at least one first and second fixtures. A cross-sectional area across a longitudinal direction of each of the at least one first and second fixtures and the at least one resilient element may have a shape corresponding to the shape of the cross-sectional area across a longitudinal direction of at least one corresponding hollow section of the hollow body. The cross-sectional area across the longitudinal direction of each of the at least one first and second fixtures and the at least one resilient element may be smaller than the cross-sectional area across the longitudinal direction of the at least one corresponding hollow section of the hollow body. The hollow body may be an extruded and/or a welded body, the at least one resilient element may be compressible in the direction of the exerted force, the at least one resilient element may be expandable upon pressure in a direction perpendicular to the exerted force, the at least one resilient element may comprise an isotropic or anisotropic material. The at least one resilient element may have a longitudinal extension less than a longitudinal extension of the hollow body, the hollow body may have an elongated shape and wherein the at least one corresponding hollow section may extend through the hollow body in the elongated direction of the hollow body. The arrangement may comprise a measuring device configured to measure a displacement of at least one of the at least one first and second fixtures. The arrangement may comprise a force transducer configured to measure the exerted force from the at least one actuator, where the at least one actuator may be arranged in a press machine. A control device may be connected to the arrangement for controlling flare testing of a hollow body.

In another embodiment, the disclosure describes a method for flare testing of a hollow body using a flare testing arrangement. The arrangement may include at least one first fixture, at least one second fixture, at least one resilient element, and at least one actuator. Each actuator may be configured to exert a force on at least one of the at least one first and second fixtures. A cross-sectional area across a longitudinal direction of each of the at least one first and second fixtures and the at least one resilient element may have a shape corresponding to the shape of a cross-sectional area across the longitudinal direction of at least one corresponding hollow section of the hollow body. The method may include exerting the force on at least one of the at least one first and second fixtures arranged in the at least one corresponding hollow section with the at least one resilient element in between, and measuring at least one of the exerted force or a displacement of at least one of the at least one first and second fixtures. In some embodiments, the method may include the registering a value of the exerted force or a value of the displacement of at least one of the at least one first and second fixtures when the hollow body fails. In some embodiments, the method may be performed by a control device.

In another embodiment, the disclosure describes a computer program comprising instructions which, when the program is executed by a computer, cause the computer to carry out the above-mentioned method. In another embodiment, the disclosure describes a computer-readable medium comprising instructions, which when executed by a computer, cause the computer to carry out the above-mentioned method.

In another embodiment, the disclosure describes a processor-implemented method for controlling an apparatus including at least one first fixture, at least one second fixture, at least one resilient element, and at least one actuator configured to exert a force on at least one of the at least one first fixture and the at least one second fixture. The method may include causing the actuator to exert a force on at least one of the at least one first fixture and the at least one second fixture, and measuring at least one of the exerted force or a displacement of at least one of the at least one first fixture and the at least one second fixture.

Additional objectives, advantages, and novel features of the invention will be apparent to one skilled in the art from the following details, and through exercising the invention. While the invention is described below, it should be apparent that the invention is not limited to the specifically described details. One skilled in the art, having access to the teachings herein, will recognize additional applications, modifications and incorporations in other areas, which are within the scope of the invention.

### BRIEF DESCRIPTION OF THE DRAWINGS

Non-limiting and non-exhaustive embodiments are described in reference to the following drawings. The components in the figures are not necessarily to scale, emphasis instead being placed upon illustrating the principles of the disclosure. In the drawings, like reference numerals refer to like parts through all the various figures unless otherwise specified.

For fuller understanding of the present disclosure and further objects and advantages of it, the detailed description set out below should be read together with the accompanying drawings, in which the same reference notations denote similar items in the various diagrams, and in which:

FIG. 1 is a schematic top view of an embodiment of a hollow body to be tested in accordance with the disclosure;

FIG. 2 is a schematic section view along line A-A in FIG. 1;

FIG. 3 is a schematic view of a flare testing arrangement for testing the hollow body in FIG. 1;

FIG. 4 is a section view along lines B-B in FIG. 3;

FIG. 5 is a section view along lines C-C in FIG. 3

FIG. 6 is a section view along lines D-D in FIG. 3;

FIG. 7 is a schematic top view of a another embodiment of a hollow body to be tested in accordance with the disclosure;

FIG. 8 is a schematic top view of first fixtures adapted to the hollow body in FIG. 7;

FIG. 9 is a schematic top view of resilient elements adapted to the hollow body in FIG. 7;

FIG. 10 is a schematic view of a flare testing arrangement for testing the hollow body in FIG. 7 in accordance with the disclosure;

FIG. 11 is a graph of a flare testing of a hollow body according to an example,

FIG. 12 is a graph of a flare testing comparison of hollow bodies in a traditional flare testing arrangement and in the flare testing arrangement according to the present disclosure;

FIG. 13 is a failed sample flare tested in a flare testing arrangement according to the present disclosure;

FIG. 14 is a passed sample flare tested in a flare testing arrangement according to the present disclosure;

FIG. 15 is a flow chart of an embodiment of a method for flare testing of a hollow body; and

FIG. 16 is a schematic view of a control unit or computer configured to perform a method of flare testing in accordance with the disclosure.

Persons of ordinary skill in the art will appreciate that elements in the figures are illustrated for simplicity and clarity so not all connections and options have been shown to avoid obscuring the inventive aspects. For example, common but well-understood elements that are useful or necessary in a commercially feasible embodiment are not often depicted in order to facilitate a less obstructed view of these various embodiments of the present disclosure. It will be further appreciated that certain actions and/or steps may be described or depicted in a particular order of occurrence while those skilled in the art will understand that such specificity with respect to sequence is not actually required. It will also be understood that the terms and expressions used herein are to be defined with respect to their corresponding respective areas of inquiry and study except where specific meaning have otherwise been set forth herein.

### DETAILED DESCRIPTION

The present disclosure now will be described more fully hereinafter with reference to the accompanying drawings, which form a part hereof, and which show, by way of illustration, specific exemplary embodiments by which the disclosure may be practiced. This disclosure may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, although it may. Furthermore, the phrase “in another embodiment” as used herein does not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and includes plural references. The meaning of “in” includes “in” and “on.”

Traditional flare testing methods may result in samples of softer materials, such as softer metal alloys, that may crush axially instead of flaring to failure. Therefore, the samples may be pretreated by tempering methods prior to testing, which incurring time and cost penalties to testing. The known flare testing method may not distribute the testing load evenly to samples, which deviate from a circular shape. This may result in a possible false passing of samples. The subjective evaluation for pass/fail criteria via visual inspection may introduce an operator variability that could result in false pass/fail results.

There is a need to develop a flare testing arrangement for a hollow body and a method for flare testing of a hollow body by a flare testing arrangement, which reduces or eliminates the need for additional processing prior to flare testing. There is also a need to develop a flare testing arrangement for a hollow body and a method for flare testing of a hollow body by a flare testing arrangement, which evenly distribute testing load onto samples having a non-circular shape. There is also a need to develop a flare testing arrangement for a hollow body and a method for flare testing of a hollow body by a flare testing arrangement, which reduces or eliminates the subjective aspect for evaluation of pass/fail results.

The object of the invention therefore is to develop a flare testing arrangement for a hollow body and a method for flare testing of a hollow body by a flare testing arrangement, which reduces or eliminates the need for additional processing prior to flare testing.

Another object of the invention is to develop a flare testing arrangement for a hollow body and a method for flare testing of a hollow body by a flare testing arrangement, which evenly distribute testing load onto samples having a non-circular shape.

A further object of the invention is to develop a flare testing arrangement for a hollow body and a method for flare testing of a hollow body by a flare testing arrangement, which reduces or eliminates the subjective aspect for evaluation of pass/fail results.

These objects are achieved with the above-mentioned flare testing arrangement for a hollow body and the method for flare testing of a hollow body by a flare testing arrangement according to the appended claims.

The present description provides an improved flare testing arrangement for a hollow body, a method for flare testing of a hollow body by a flare testing arrangement, a computer program and a computer-readable medium.

According to the present disclosure there is provided a flare testing arrangement for a body, the body having at least one hollow section extending in a longitudinal direction of the body. The arrangement comprises: at least one first fixture; at least one second fixture; at least one resilient element; at least one actuator, each configured to exert a force on at least one of the at least one first and second fixtures; wherein a cross-sectional area across a longitudinal direction of each of the at least one first and second fixtures and the at least one resilient element has a shape corresponding to the shape of the cross-sectional area across a longitudinal direction of at least one corresponding hollow section of the hollow body. Since the cross-sectional area of the first and second fixtures and the resilient element, each has a shape corresponding to the shape of the cross-sectional area of the corresponding hollow section of the hollow body, the flare testing arrangement reduces or may eliminate the need for additional processing prior to the flare testing. The force exerted by the at least one actuator affects the at least one resilient element such that load is evenly distributed onto samples. Such flare testing arrangement is not limited to circular shapes, nor to only one hollow section of the hollow body but may be extended to non-round hollows and multi-hollow bodies. Since the at least one resilient element may be adapted to samples having a non-circular shape of the hollow section, the load will be evenly distributed onto the samples. The exerted force and the evenly distributed load can be controlled such that subjective aspects for evaluation of pass/fail results can be eliminated.

The cross-sectional area across the longitudinal direction of each of the at least one first and second fixtures and the at least one resilient element, may be smaller than the cross-sectional area across the longitudinal direction of the at least one corresponding hollow section of the hollow body. The definition of smaller in this context results in that each of the at least one first and second fixtures and the at least one resilient element have a shape of a smaller cross-section compared with the extruded section which allows for easy insertion yet maintains sufficient size to provide enough perpendicular force onto the sides of the extruded hollow when the resilient element is compressed Expressed in another way, the cross-sectional area across the longitudinal direction of the at least one corresponding hollow section of the hollow body is larger than the cross-sectional area across the longitudinal direction of each of the at least one first and second fixtures and the at least one resilient element. The at least one first and second fixtures and the at least one resilient element are displaced in the at least one hollow section of the hollow body, during installation of the hollow body in the flare testing arrangement. Further, during testing, the at least one first and second fixtures and the at least one resilient element are displaced in the at least one hollow section of the hollow body. The at least one first and second fixtures and the at least one resilient element are made to fit inside the hollow section, and to be movable or displaceable in the hollow section of the hollow body.

The hollow body may be an extruded body, a welded body or a casted body.

The hollow body may be an extruded aluminium profile, having at least one open end and at least one hollow section. Alternatively, the hollow body may be made by welding. Depending on the shape of the hollow body, it may also be possible to cast the hollow body. The direction of the hollow section in relation to a longitudinal direction of the hollow body, the geometry of the hollow section or sections, and possible variations of different cross-sections of the hollow body may affect the choice of manufacturing method. The hollow body may have different characteristics and strengths depending on the manufacturing method. The flare testing arrangement according to the present disclosure may evaluate the hollow bodies completed by these different manufacturing methods. The material used in the hollow body may be aluminium alloys, plastics, steel alloys or composites, or a combination of these materials.

The at least one resilient element is compressible in the direction of the exerted force. Upon pressure of the exerted force, the at least one resilient element expands in a direction perpendicular to the exerted force. The expansion of the resilient element in the direction perpendicular to the exerted force, should evenly distribute load from the exerted force on the walls within the hollow section.

The at least one resilient element may comprise an isotropic or anisotropic material. Isotropic and anisotropic materials are compressible. The isotropic or anisotropic material may have a stiffness or spring rate, which is lower than the material in the hollow body being tested. The isotropic or anisotropic material should transfer the axial force into an evenly applied radial force perpendicular to the applied force. A flexible/compressible isotropic or anisotropic material should have a stiffness which is able to convert the applied axial force into a perpendicular force exerting against the sides of the extrusion and which is able to resume its original uncompressed shape when the axial force is removed.

The at least one resilient element may have a longitudinal length less than the longitudinal length of the hollow body. This may facilitate the insertion of the hollow body in the flare testing arrangement, since it will allow placing a part of the at least one first and second fixtures in the hollow section, with the at least one resilient element there between. Further, if the distributed load from the exerted force should be concentrated on a specific part of the hollow body along its longitudinal extension, the resilient element may be displaced and located to this part before the flare testing starts. Such a location of the resilient element is possible if the resilient element is shorter than the hollow body.

The hollow body may have an elongated shape and wherein the at least one corresponding hollow section extends through the hollow body in the elongated direction of the hollow body. Such configuration of the hollow body may be similar to an extruded hollow body. The hollow section may extend all the way from one end to an opposite end in the elongated direction of the hollow body. Such configuration of the hollow body may also be achieved by welding or by casting. The flare testing arrangement according to the present disclosure may be used for flare testing of hollow bodies having such a configuration.

The arrangement comprises a measuring device, configured to measure a displacement of at least one of the at least one first and second fixtures. The measuring device may be connected to the at least one actuator. The exerted a force will displace at least one of the first and second fixtures in the hollow section of the hollow body during compression of the at least one resilient element. The measuring device may during the displacement of the at least one of the first and second fixtures register the amount of displacement of the at least one of the first and second fixtures. The measuring device may be a length sensor.

The arrangement may comprise a force transducer, configured to measure the exerted force from the at least one actuator. The exerted force from the at least one actuator may be linear or constant during the flare testing or the exerted force may vary. If a number of actuators are used in the flare testing arrangement, the exerted force from each actuator may be equal or different depending on the hollow body to be tested. Each actuator may be provided with a force transducer, which register and measure the exerted force. The actuator may be an electric, hydraulic and/or pneumatic driven actuator.

The at least one actuator may be arranged in a press machine. The flare testing arrangement may be a press machine with electric, hydraulic and/or pneumatic driven actuators, which exerts force on the at least one of the at least one first and second fixtures. The press machine may have a foundation on which the at least one first and second fixtures, the at least one resilient element and the hollow body rest. The at least one actuator may be arranged in a yoke above the foundation. Pillars or columns may be arranged to bear the yoke above the foundation.

A control device may be connected to the arrangement for controlling flare testing of a hollow body. The control device may control the flare testing arrangement and thus the flare testing. The control device may be connected to the at least one actuator, the measuring device and the force transducer. The control device may instruct the at least one actuator to exert force. The control device may receive information about the size/magnitude of the force and the displacement of the at least one actuator and thus of the at least one of the first and second fixtures during the flare testing. A computer may be connected to the control device. The control device may itself be a computer.

According to a second aspect, there is provided a method for flare testing of a hollow body by a flare testing arrangement. The arrangement comprising: at least one first fixture; at least one second fixture; at least one resilient element; at least one actuator, each configured to exert a force on at least one of the at least one first and second fixtures; wherein a cross-sectional area across a longitudinal direction of each of the at least one first and second fixtures and the at least one resilient element has a shape corresponding to the shape of a cross-sectional area across the longitudinal direction of at least one corresponding hollow section of the hollow body, the method comprises the steps of: exerting the force on at least one of the at least one first and second fixtures arranged in the at least one corresponding hollow section with the at least one resilient element in between; and measuring the exerted force and/or a displacement of at least one of the at least one first and second fixtures. The force exerted by the at least one actuator affects the at least one resilient element such that load is evenly distributed onto samples. The exerted force and the evenly distributed load can be controlled such that subjective aspects for evaluation of pass/fail results can be eliminated. If a specific sample resists a specific controlled exerted force and displacement of the actuator, the sample may be evaluated as a pass. However, if the specific sample flares at the specific controlled exerted force and displacement of the actuator, the sample may be evaluated as a fail. The specific controlled exerted force and displacement of the actuator, may be a set threshold value or a threshold value achieved during testing of a number of reference samples. The exerted force will displace at least one of the first and second fixtures in the hollow section of the hollow body during compression of the at least one resilient element. The measuring device may during the displacement of the at least one of the first and second fixtures register the amount of displacement of the at least one of the first and second fixtures. Each actuator may be provided with a force transducer, which register and measure the exerted force.

The method comprises the further step of: registering a value of the exerted force and/or a value of the displacement of at least one of the at least one first and second fixtures when the hollow body fails. A value of the exerted force and a value of the displacement when the hollow body fails is registered. Threshold limit values of the force and the displacement can thereafter be set. The hollow bodies must resist these limit values of the force and the displacement without flaring in order to be evaluated for a pass. The measuring device may comprise an active feedback loop between the actuator exerting the force and the sensors that monitor the force and displacement readings of the equipment. Using this with pre-defined thresholds for pass fail criteria.

The method is performed by a control device. The control device may control the flare testing arrangement and thus the method steps of the flare testing. The control device may be connected to the at least one actuator, the measuring device and the force transducer. The control device may instruct the at least one actuator to exert force. The control device may receive information about the size and magnitude of the force and the displacement of the at least one actuator and thus of the at least one of the first and second fixtures during the flare testing. A computer may be connected to the control device. The control device may itself be a computer.

According to an example, there is provided a computer program comprising instructions which, when the program is executed by a computer, cause the computer to carry out the above-described method. A computer-readable medium comprising instructions, which when executed by a computer, cause the computer to carry out the method. This has the advantage that the method may be comprised in pre-programmed software, which may be implemented into the flare testing arrangement suitable for utilizing the method.

### EXAMPLE EMBODIMENTS

The present disclosure will now be described with reference to the accompanying drawings, in which preferred example embodiments of the disclosure are shown. The disclosure may, however, be embodied in other forms and should not be construed as limited to the herein disclosed embodiments. The disclosed embodiments are provided to fully convey the scope of the disclosure to the skilled person.

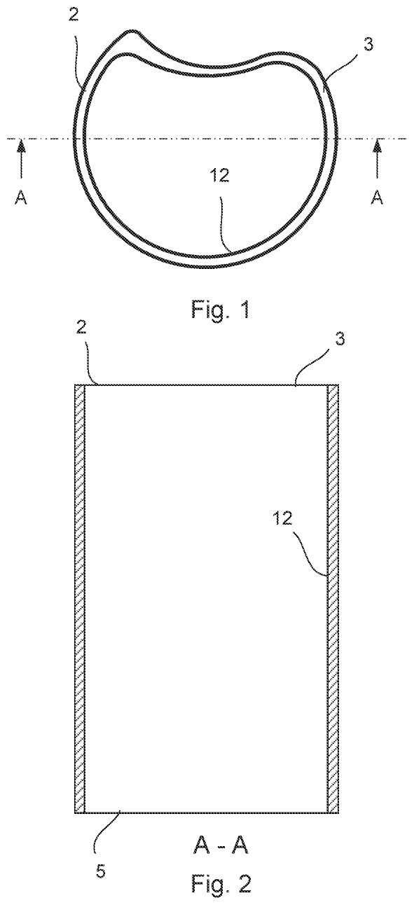

FIG. 1 schematically illustrates a view from above of an embodiment of a hollow body 2 to be tested. The hollow body 2 may be extruded or welded, and be used as a component in a structure. The hollow body 2 may have an elongated shape. A hollow section 12 may extend through the hollow body 2 in the elongated direction of the hollow body 2. In some embodiments, the hollow body 2 may have a non-circular shape. FIG. 2 schematically illustrates a cross-section view along line A-A in FIG. 1. The hollow body 2 has an elongated extension from a first end surface 3 to a second end surface 5.

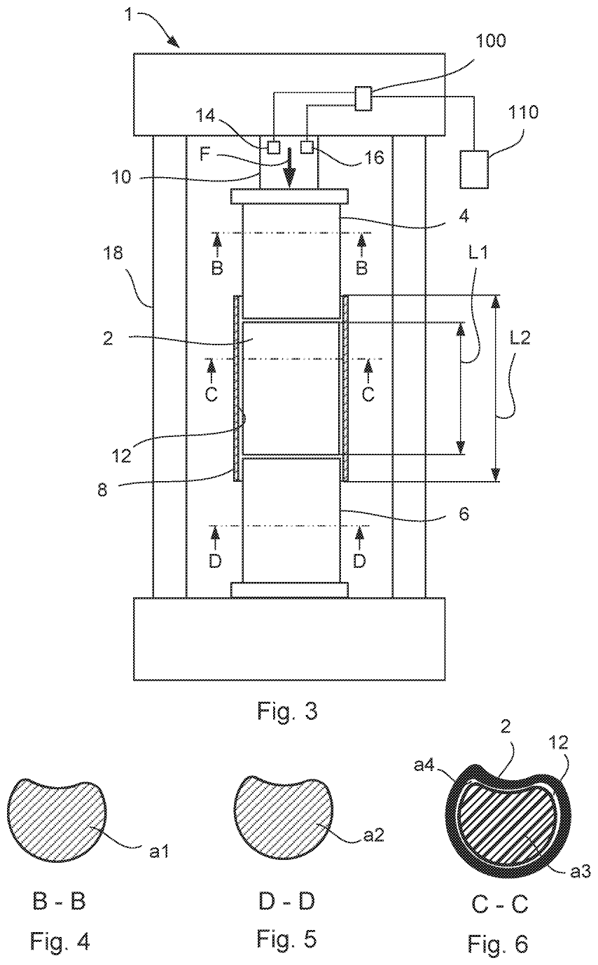

FIG. 3 schematically illustrates an embodiment of a flare testing arrangement 1 that may be for testing the hollow body in FIG. 1, for example. The hollow body 2 according to FIGS. 1 and 2 may be arranged to be flare tested as a sample in the flare testing arrangement 1. The flare testing arrangement 1 may include a first fixture 4, a second fixture 6 and a resilient element 8. An actuator 10 may be configured to exert a force F on the fixture 4. In some embodiments, the actuator 10 may be arranged in a press machine 18. In some embodiments, the resilient element 8 may be compressible in the direction of the exerted force F and may be expandable upon pressure in a direction perpendicular to the exerted force F. The resilient element 8 may include an isotropic or anisotropic material. In some embodiments, the resilient element 8 may have a longitudinal extension L1 less than a longitudinal extension L2 of the hollow body 2.

The arrangement 1 may include a measuring device 14 configured to measure a displacement D of the first fixture 4. The arrangement 1 may include a force transducer 16, which may be configured to measure the exerted force F from the at least one actuator 10. A control device 100 may be connected to the arrangement 1 for controlling the flare testing of the hollow body 2. A computer 110 is connected to the control device 100.

FIG. 4-6 schematically illustrate cross-section views along lines B-B, C-C, D-D in FIG. 3. The cross-sectional area a1, a2, a3 across a longitudinal direction of each of the first and second fixtures 4, 6 and the resilient element 8 may have a shape corresponding to the shape of the cross-sectional area a4 across a longitudinal direction of at least one corresponding hollow section 12 of the hollow body 2. In some embodiments, the cross-sectional area a1, a2, a3 across the longitudinal direction of each of the at least one first and second fixtures 4, 6 and the at least one resilient element 8 may be smaller than the cross-sectional area a4 across the longitudinal direction of the at least one corresponding hollow section 12 of the hollow body 2.

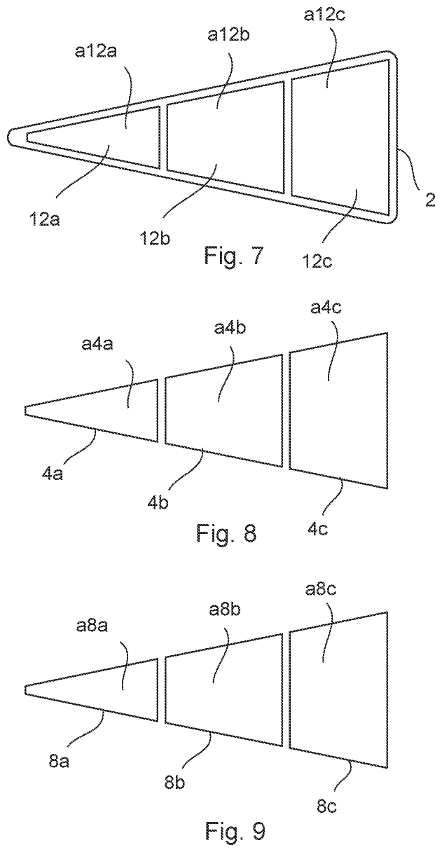

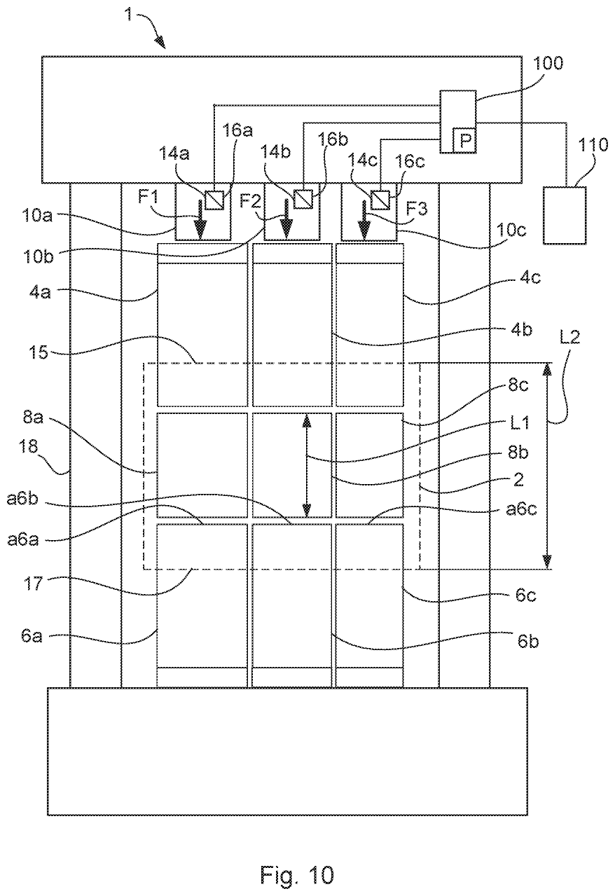

FIG. 7 schematically illustrates a top view of another embodiment of a hollow body 2 to be tested. The hollow body 2 may be extruded or welded, and may be used as a component in a structure. The hollow body 2 may have an elongated shape and three hollow sections 12a, 12b, 12c, which may extend through the hollow body 2 in the elongated direction of the hollow body 2. In some embodiments, the shape of the hollow sections 12a, 12b, 12c may be different from each other. FIG. 8 schematically illustrates a top view of embodiments of three first fixtures 4a, 4b, 4c that may be adapted to the hollow body in FIG. 7. FIG. 9 schematically illustrates a top view of embodiments of three resilient elements 8a, 8b, 8c that may be adapted to the hollow body in FIG. 7. The cross-sectional area a4a, a4b, a4c and a8a, a8b, a8c across a longitudinal direction of each of the first fixtures 4a-4c and each of the resilient elements 8a-8c, respectively, may have a shape corresponding to the shape of the respective cross-sectional area a12a, a12b, a12c across a longitudinal direction of the corresponding hollow section 12a-12c of the hollow body 2. The cross-sectional area a4a-a4c; a8a-a8c across the longitudinal direction of each first fixtures 4a-4c and of each resilient elements 8a-8c, respectively, may be smaller than the cross-sectional area a12a-a12c across the longitudinal direction of the corresponding hollow section 12a-12c of the hollow body 2. In some embodiments, second fixtures 6a, 6b, 6c (see e.g., FIG. 10) may have a configuration similar and/or corresponding to the configuration of the first fixtures 4a, 4b, 4c. The second fixtures 6a, 6b, 6c may each have a cross-sectional area a6a, a6b, a6c similar/corresponding to the cross-sectional area a4a, a4b, a4c of the first fixtures 4a, 4b, 4c, respectively.

FIG. 10 schematically illustrates an embodiment of a flare testing arrangement for testing the hollow body in FIG. 7. The hollow body 2 according to FIG. 7 may be arranged to be flare tested as a sample in the flare testing arrangement 1. The hollow body 2 is schematically illustrated by dashed lines in FIG. 10. The hollow body 2 may have an elongated extension from a first end surface 15 to a second end surface 17. In some embodiments, the flare testing arrangement 1 may include three first fixtures 4a, 4b, 4c, three second fixtures 6a, 6b, 6c, and three resilient elements 8a, 8b, 8c. Three actuators 10a, 10b, 10c may be configured to exert a force F1, F2, F3, respectively on the three first fixtures 4a, 4b, 4c. In some embodiments, the actuators 10a-10c may be arranged in a press machine 18. The resilient elements 8a-8c may be compressible in the direction of the exerted forces F1, F2, F3, respectively, and may be expandable upon pressure in a direction perpendicular to the exerted forces F1, F2, F3. In some embodiments, the resilient elements 8a-8c may include an isotropic or anisotropic material, such as polyurethane. The resilient elements 8a-8c may each have a longitudinal extension L1 less than a longitudinal extension L2 of the hollow body 2.

The arrangement 1 may include measuring devices 14a, 14b, 14c, configured to measure displacement D of the respective first fixtures 4a-4c. The arrangement 1 may include force transducers 16a, 16b, 16c configured to measure the exerted force F1, F2, F3 from each actuator 10a-10c, respectively. A control device 100 may be connected to the arrangement 1 for controlling the flare testing of the hollow body 2. A computer 110 may be connected to the control device 100.

In some embodiments, the exerted force F1, F2, F3 from each actuator 10a-10c may be identical or substantially identical. Further, in some embodiments, the actuator 10a-10c may be configured to be displaced simultaneously and equally during the flare testing.

FIG. 11 schematically illustrates a graph of a flare testing of an embodiment of a hollow body 2 according to an example. In some embodiments, when the actuators 10a, 10b, 10c (see, e.g., FIGS. 3 and 10) exert a force F, F1, F2, F3 on the fixtures 4, 4a-4c; 6, 6a-6c, they may be displaced in the direction towards each other and compress the resilient elements 8, 8a-8c in the direction of the exerted force F, F1, F2, F3, so that they may expand in the corresponding hollow section 12, 12a-12c in a direction perpendicular to the exerted force F, F1, F2, F3. The exerted force F, F1, F2, F3 and the displacement D, D1, D2, D3 of at least one of the at least one first and second fixtures 4, 4a-4c; 6, 6a-6c may be measured and graph over the exerted force F, F1, F2, F3 and the displacement D, D1, D2, D3 may be achieved. A value of the exerted force Fv, F1v, F2v, F3v and a value of the displacement Dv, Dv1, Dv2, Dv3 when the hollow body 2 fails may be registered. Limit values of the force FL and the displacement DL may thereafter be set, which, in some embodiments, hollow bodies 2 must resist without flaring in order to be evaluated for a pass.

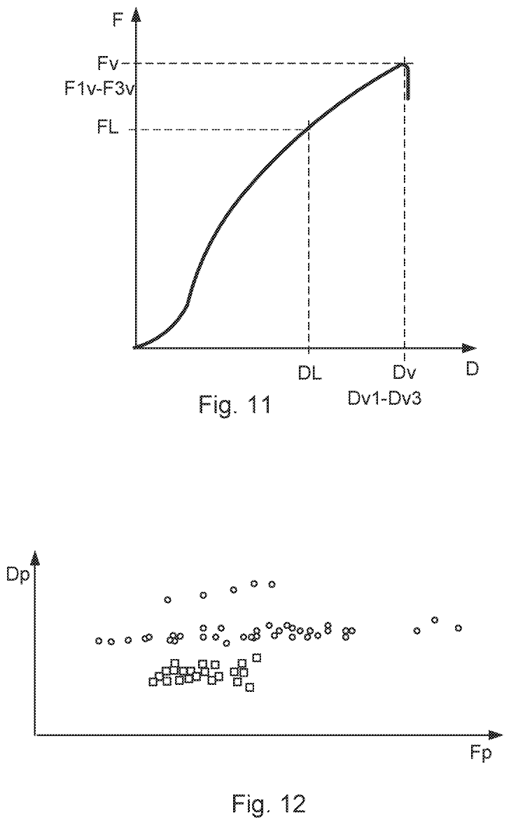

FIG. 12 illustrates a graph of an embodiment of a flare testing comparison between hollow bodies 2 in a traditional flare testing arrangement (not shown) and in the flare testing arrangement 1 according to the present disclosure. The graph shows force Fp vs displacement Dp of samples of hollow bodies 2 tested with a traditional cone flare method, which test results are represented with circular dots in the figure, and also of samples of hollow bodies 2 tested with the method and arrangement 1 according to the present disclosure, which test results are represented with square dots in the figure. From the graph, it is evident that the test results for the method and arrangement 1 according to the present disclosure has a tighter range of values compared to the traditional cone flare method, which may reduce or eliminate the subjective aspect for evaluation of pass/fail results.

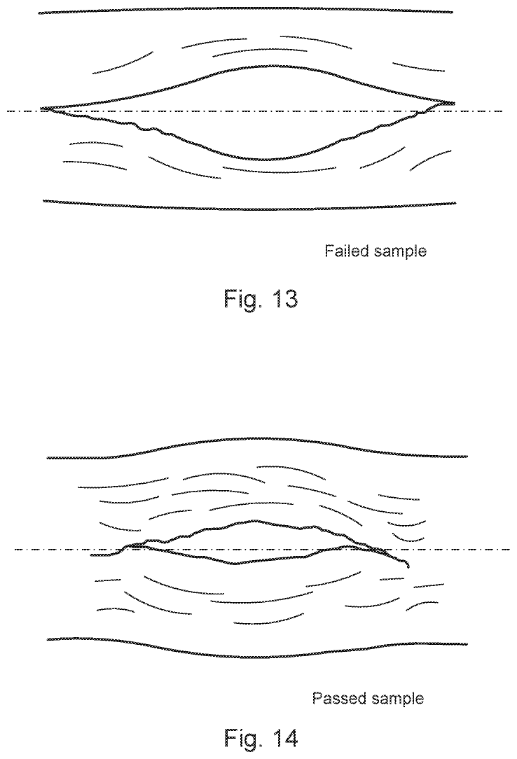

FIGS. 13 and 14 illustrate a failed sample of a hollow body 2 and a passed sample of a hollow body 2, which are flare tested in a flare testing arrangement 1 according to the present disclosure. The failed sample of the hollow body 2 in FIG. 13 has flared longitudinally in the hollow body 2 without significant expansion and plastic deformation of the hollow body 2. The passed sample of the hollow body 2 in FIG. 14 has flared longitudinally in the hollow body 2. However, the hollow body 2 has also expanded and has been plastic deformed, which indicates that the hollow body 2 has resisted a large force before flaring.

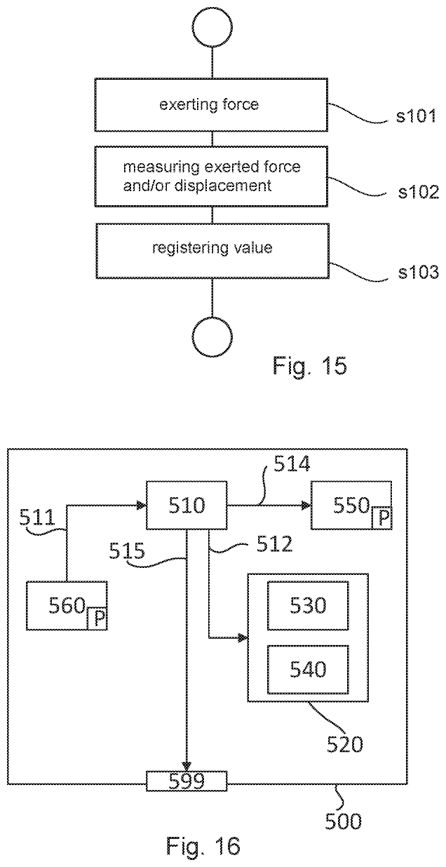

FIG. 15 shows a flow chart of a method for flare testing of a hollow body 2 by a flare testing arrangement 1 according to the disclosure. In some embodiments, the method may relate to the flare testing arrangement 1 disclosed and described with respect to FIGS. 3 and 10.

In some embodiments, the method includes exerting s101 the force F, F1, F2, F3 on at least one of the at least one first and second fixtures 4, 4a-4c; 6, 6a-6c arranged in the at least one corresponding hollow section 12, 12a-12c with the at least one resilient element 8,8a-8c in between; and measuring s102 the exerted force F, F1, F2, F3 and/or a displacement D, D1, D2, D3 of at least one of the at least one first and second fixtures 4, 4a-4c; 6, 6a-6c.

The method may include registering s103 a value of the exerted force Fv, F1v, F2v, F3v and/or a value of the displacement Dv, Dv1, Dv2, Dv3 of at least one of the at least one first and second fixtures 4, 4a-4c; 6, 6a-6c when the hollow body 2 fails.

In some embodiments, the method above may be performed by a control device 100. In some embodiments, a computer program P comprising instructions which, when the program P is executed by a computer 500 including one or more processors, may cause the computer 100, 500 to carry out the above-described method. In some embodiments, the controller or another computer may include a non-transitory computer-readable medium comprising instructions, which when executed by a computer 100, 500 may cause the computer 100, 500 to carry out the above-mentioned method steps.

FIG. 16 schematically illustrates an embodiment of a computer or a device 500 configured to perform the method according to the second aspect. The control device 100 of the particle protection device 32 may, in some embodiments, include the device 500. The device 500 may include a non-volatile memory 520, a data processing unit 510 and a read/write memory 550. The non-volatile memory 520 may have a first memory element 530 in which a computer program, e.g. an operating system, may be stored for controlling the function of the device 500. The device 500 may further comprise a bus controller, a serial communication port, I/O means, an A/D converter, a time and date input and transfer unit, an event counter and an interruption controller (not depicted). The non-volatile memory 520 has also a second memory element 540.

In some embodiments, there may be provided a computer program P which comprises routines for performing the safety method. The program P may be stored in an executable form or in a compressed form in a memory 560 and/or in a read/write memory 550.

Where the data processing unit 510 is described as performing a certain function, it may mean that the data processing unit 510 affects a certain part of the program stored in the memory 560 or a certain part of the program stored in the read/write memory 550.

The data processing device 510 may communicate with a data port 599 via a data bus 515. The non-volatile memory 520 may be intended for communication with the data processing unit 510 via a data bus 512. The separate memory 560 may be intended to communicate with the data processing unit 510 via a data bus 511. The read/write memory 550 may be adapted to communicating with the data processing unit 510 via a data bus 514.

When data are received on the data port 599, they may be stored temporarily in the second memory element 540. When input data received have been temporarily stored, the data processing unit 510 may be prepared to effect code execution as described above.

Parts of the methods herein described may be effected by the device 500 by means of the data processing unit 510 which runs the program stored in the memory 560 or the read/write memory 550. When the device 500 runs the program, methods herein described are executed.

The foregoing description of the examples has been furnished for illustrative and descriptive purposes. It is not intended to be exhaustive, or to limit the examples to the variants described. Many modifications and variations will obviously be apparent to one skilled in the art. The examples have been chosen and described in order to best explicate principles and practical applications, and to thereby enable one skilled in the art to understand the examples in terms of its various examples and with the various modifications that are applicable to its intended use. The components and features specified above may, within the framework of the examples, be combined between different examples specified.

1. A flare testing arrangement for a hollow body, the hollow body having at least one hollow section extending in a longitudinal direction of the hollow body, the arrangement comprising:
at least one first fixture;
at least one second fixture;
at least one resilient element; and
at least one actuator configured to exert a force on at least one of the at least one first fixture and the at least one second fixture;
wherein a cross-sectional area across a longitudinal direction of each of the at least one first fixture, the at least one second fixture, and the at least one resilient element has a shape corresponding to the shape of a cross-sectional area across the longitudinal direction of the at least one corresponding hollow section of the hollow body.

2. The arrangement of claim 1, wherein the cross-sectional area across the longitudinal direction of each of the at least one first fixture, the at least one second fixture, and the at least one resilient element is smaller than the cross-sectional area across the longitudinal direction of the at least one corresponding hollow section of the hollow body.

3. The arrangement of claim 1, wherein the hollow body is at least one of an extruded body, a welded body, or a casted body.

4. The arrangement of claim 1, wherein the at least one resilient element is compressible in the direction of the exerted force.

5. The arrangement of claim 4, wherein the at least one resilient element is expandable upon pressure in a direction perpendicular to the exerted force.

6. The arrangement of claim 5, wherein the at least one resilient element comprises at least one of an isotropic or an anisotropic material.

7. The arrangement of claim 1, wherein the at least one resilient element has a longitudinal extension less than or equal to a longitudinal extension of the hollow body.

8. The arrangement or claim 1, wherein the hollow body has an elongated shape and wherein the at least one corresponding hollow section extends through the hollow body in the elongated direction of the hollow body.

9. The arrangement of claim 1, wherein the arrangement further comprises a measuring device configured to measure a displacement of at least one of the at least one first fixture and the at least one second fixture.

10. The arrangement of claim 1 further comprising a force transducer configured to measure the exerted force from the at least one actuator.

11. The arrangement of claim 1, wherein the at least one actuator is disposed in a press machine.

12. The arrangement of claim 1 further comprising a control device for controlling flare testing of the hollow body.

13. A method for flare testing of a hollow including at least one hollow section extending in a longitudinal direction of the hollow body, the method comprising:
providing a flare testing arrangement including:
at least one first fixture;
at least one second fixture;
at least one resilient element; and
at least one actuator configured to exert a force on at least one of the at least one first fixture and the at least one second fixture,
wherein a cross-sectional area across a longitudinal direction of each of the at least one first fixture, the at least one second fixture, and the at least one resilient element has a shape corresponding to the shape of a cross-sectional area across the longitudinal direction of the at least one corresponding hollow section of the hollow body;
arranging at least one of the at least one first fixture and the at least one second fixture in the at least one corresponding hollow section with the at least one resilient element disposed between the at least one first fixture and the at least one second fixture;
exerting the force on at least one of the at least one first fixture and the at least one second fixture; and
measuring at least one of the exerted force or a displacement of at least one of the at least one first fixture and the at least one second fixture.

14. The method of claim 13 further comprising:
exerting the force on at least one of the at least one first fixture and the at least one second fixture until the hollow body fails; and
registering at least one of a value of the exerted force or a value of the displacement of at least one of the at least one first fixture and the at least one second fixture when the hollow body fails.

15. The method according to claim 13, wherein the method is performed by a control device by executing a computer program.

16. A processor-implemented method for controlling an apparatus including at least one first fixture, at least one second fixture, at least one resilient element, and at least one actuator configured to exert a force on at least one of the at least one first fixture and the at least one second fixture, the method including:
causing the actuator to exert a force on at least one of the at least one first fixture and the at least one second fixture; and
measuring at least one of the exerted force or a displacement of at least one of the at least one first fixture and the at least one second fixture.

17. The method of claim 16, wherein a cross-sectional area across a longitudinal direction of each of the at least one first fixture, the at least one second fixture, and the at least one resilient element has a shape corresponding to the shape of a cross-sectional area across a longitudinal direction of at least one corresponding hollow section of a hollow body.

18. The method of claim 16, wherein at least one of the at least one first fixture and the at least one second fixture are arranged in at least one corresponding hollow section of a hollow body with the at least one resilient element disposed between the at least one first fixture and the at least one second fixture, the method further comprising:
exerting the force on at least one of the at least one first fixture and the at least one second fixture until the hollow body fails; and
registering at least one of a value of the exerted force or a value of the displacement of at least one of the at least one first fixture and the at least one second fixture when the hollow body fails.

19. The method of claim 16, wherein the apparatus further comprises a force transducer configured to measure the exerted force from the at least one actuator.

20. The method of claim 16, wherein the apparatus further comprises a measuring device configured to measure a displacement of at least one of the at least one first fixture and the at least one second fixture.
